(19) United States
(12) Patent Application Publication
(10) Pub. No.: US 2014/0172368 A1
(43) Pub. Date: Jun. 19, 2014

(54) FLAME INSTABILITY DETECTION AND IDENTIFICATION IN INDUSTRIAL FURNACES

(71) Applicants: Weichang Li, Annandale, NJ (US); Gary T. Dobbs, Fairfax, VA (US); Limin Song, West Windsor, NJ (US); Peng Xu, Annandale, NJ (US); Krishnan Kumaran, Raritan, NJ (US); Mark M. Disko, Glen Gardner, NJ (US); Jeffrey M. Grenda, Houston, TX (US); San Chhotray, Centreville, VA (US); Amy B. Herhold, Short Hills, NJ (US); Duane R. McGregor, Gainesville, VA (US)

(72) Inventors: Weichang Li, Annandale, NJ (US); Gary T. Dobbs, Fairfax, VA (US); Limin Song, West Windsor, NJ (US); Peng Xu, Annandale, NJ (US); Krishnan Kumaran, Raritan, NJ (US); Mark M. Disko, Glen Gardner, NJ (US); Jeffrey M. Grenda, Houston, TX (US); San Chhotray, Centreville, VA (US); Amy B. Herhold, Short Hills, NJ (US); Duane R. McGregor, Gainesville, VA (US)

(73) Assignee: EXXONMOBIL RESEARCH AND ENGINEERING COMPANY, Annandale, NJ (US)

(21) Appl. No.: 14/101,677

(22) Filed: Dec. 10, 2013

Related U.S. Application Data
(60) Provisional application No. 61/737,885, filed on Dec. 17, 2012.

(51) Int. Cl. G01M 99/00; G06F 17/11

(52) U.S. Cl. CPC G01M 99/00; G06F 17/11
USPC 702/182

(57) ABSTRACT

Systems and methods for multi-channel detection of an instability in a furnace comprising a plurality of detectors are disclosed. Each of a plurality of detectors provides a first measurement related to the plurality of burners when the furnace is operating in a stable condition. A stable signal component representation is determined based on the first measurement from each of the plurality of detectors. Each of a plurality of detectors provides a second measurement related to the plurality of burners when the furnace is operating in an unknown state. An unstable signal component representation is determined based on the stable signal component representation and a second measurement from each of the plurality of detectors. An instability is detected based on the unstable signal component representation and an instability threshold.

### CROSS-REFERENCE TO RELATED APPLICATIONS

This application claims priority to U.S. Provisional Application Ser. No. 61/737,885 filed Dec. 17, 2012, which is herein incorporated by reference in its entirety.

### FIELD

The invention is generally related to flame instability detectors. Particularly, the present application relates to monitoring a flame state and identifying an instability using a multi-channel detector. The present application further relates to identification of unstable burners in a furnace with multiple burners.

### BACKGROUND

Furnace monitoring is becoming an increasingly important problem in refinery operations. Industrial furnaces, fired heaters, and boilers are used extensively across multiple refinery processes such as process heating and steam production, and are generally responsible for the largest proportion of the total refinery fuel consumption. The proper operation of these furnaces is particularly relevant for safety, environmental, and energy efficiency concerns.

In addition, industrial furnaces can contribute substantially to total refinery NOx emissions. NOx emissions can be reduced through lowering the adiabatic flame temperature while maintaining safe operation, which can be achieved by, e.g., enhancing fuel gas recirculation, steam injection, or use of technologies such as premixed flames and ultra-low NOx s. However, these technologies are often more prone to flame instability than tradition processes. It therefore is necessary to monitor the burner stability and provide feedback signals to control fuel and/or diluent flow when instabilities occur.

Traditionally, flame monitoring in industrial furnaces has been accomplished through visual inspection, analyzer-based monitoring, and photodetector devices. Visual inspection can readily identify flame blowoff, but is generally inadequate for identifying instability prior to blowoff. Analyzer-based monitoring typically has long latency and lacks the dynamic coverage needed for reliable detection. Photodetector devices such as flame eye are mainly burner based and expensive for wide-deployment. Furthermore, the practical use of line-of-sight techniques, such as Tunable Diode Laser-based monitoring can be restricted due to their design.

New flame monitoring strategies have been introduced, but are limited in various ways. For example, variance-based approaches have been proposed, but are limited due to their low output signal-to-noise ratio, which requires an operator to choose between early detection and a low false positive rate. In addition, draft pressure fluctuation approaches have been reported in the past, but these techniques have been limited to a specific frequency range.

### SUMMARY

The purpose and advantages of the present application will be set forth in and apparent from the description that follows, as well as will be learned by practice of the disclosed subject matter. Additional advantages of the disclosed subject matter will be realized and attained by the method and apparatus particularly pointed out in the written description and claims hereof, as well as from the appended drawings.

To achieve these and other advantages and in accordance with the purpose of the application, as embodied and broadly described, the disclosed subject matter includes a method for detecting an instability in a furnace having a plurality of burners. The method can include the steps of obtaining from each of plurality of detectors a first measurement related to the plurality of burners when the furnace is operating in a stable condition, determining, based at least in part on the first measurement from each of the plurality of detectors, a stable signal component representation for the furnace, obtaining from each of the plurality of detectors a second measurement related to the plurality of burners when the furnace is operating in an unknown state, determining, based at least in part on the second measurement from each of the plurality of detectors and the stable signal component representation, an unstable signal component representation for the furnace, and detecting, using at least one processor, an instability in the furnace based at least in part on the unstable signal component representation and an instability threshold.

For example, the plurality of detectors can comprise a plurality of pressure sensors, a plurality of vibration sensors, or a plurality of video sensors.

In accordance with one embodiment of the disclosed subject matter, the stable signal component representation for the furnace can be a stable covariance matrix. The unstable signal component representation can be an instability component covariance. The instability component covariance can be calculated based on a stable covariance matrix and a current covariance matrix. The current covariance matrix can be calculated based on the stable covariance matrix and a vector of the second measurement from each of the plurality of burners.

In accordance with another embodiment of the disclosed subject matter, the instability threshold is compared against a detection test statistic. The detection test statistic can be, for example, a Neyman-Pearson detector. The detection test statistic can be computed based on the inverse of a stable covariance matrix. In another embodiment, the detection test statistic can be calculated based on an inverse of a current covariance matrix. For example, the inverse of the current covariance matrix can be computed via matrix inversion lemma.

In accordance with another embodiment of the disclosed subject matter, the plurality of detectors can comprise one or more detectors of a first detector type and one or more detectors of a second detector type. The first measurement can be obtained by obtaining a first time series of measurements from each of one or more detectors of a first detector type, the first detector type having a first sampling rate, and obtaining a second time series of measurements from each of the one or more detectors of a second detector type, the second time series of measurements from each of the one or more detectors of a second detector type having a second sampling rate. For example, the first time series of measurements can include the first measurement for each of the one or more detectors of the first detector type, and the second time series can include the first measurement for each of the one or more detectors of a second detector type.

The method can further include converting the first time series of measurements and the second time series of measurements into a combined time series of measurements having a common sampling rate, wherein determining the stable signal component representation of the furnace comprises determining the stable signal component representation for the furnace based at least in part on the combined time series measurements. The common sampling rate can be, for example, the first sampling rate, or a sampling rate other than the first sampling rate and the second sampling rate.

The first time series of measurements can also include the second measurement for each of the one or more detectors of a first detector type, and the second time series of measurements can include the second measurement for each of the one or more detectors of a second detector type. The first time series of measurements and the second time series of measurements can be converted into a combined time series of measurements having a common sampling rate. The unstable signal component representation for the furnace can be determined based at least in part on the combined time series of measurements.

In accordance with one embodiment of the disclosed subject matter, the first time series of measurements includes at least one video frame. The at least one video frame can be converted into a single value. For example, the at least one video frame can be converted into a single value based on an intensity of each pixel in the at least one video frame. The second time series of measurements can include, for example, at least one value measured by a pressure sensor.

In accordance with another embodiment of the disclosed subject matter, the method can further include identifying an unstable subset of burners based at least in part on the unstable signal component representation. The unstable signal component representation can be, for example, an instability component covariance. Eigenvalue decomposition of the unstable signal component representation can be used to obtain at least one dominant eigenvector. The at least one dominant eigenvector can include three components defining a point on a unit ball.

As disclosed herein, the point can be clustered with a plurality of other points obtained from a plurality of previous dominant eigenvectors. The unstable subset of burners can be identified based on the clustering. Historical data can be used to identify the unstable subset of burners. In accordance with another embodiment, a Green's function vector can be recovered from the at least one dominant eigenvector. For example, the at least one dominant eigenvector can be normalized to obtain the Green's function vector.

As disclosed herein, the unstable subset of burners can include a single burner, a plurality of burners, or a group of burners including at least one unstable burner.

Also disclosed herein is a system for detecting an instability in a furnace having a plurality of burners. The system can include a plurality of detectors and at least one processor coupled to the plurality of detectors. The plurality of detectors is configured to obtain from each of the plurality of detectors a first measurement related to the plurality of burners when the furnace is operating in a stable condition, determine, based at least in part on the first measurement from each of the plurality of detectors, a stable signal component representation for the furnace, obtain from each of the plurality of detectors a second measurement related to the plurality of burners when the furnace is operating in an unknown state, determine, based at least in part on the second measurement from each of the plurality of detectors and the stable signal component representation, an unstable signal component representation for the furnace, and detect an instability in the furnace based at least in part on the unstable signal component representation and an instability threshold. Additional aspects and features of the system are described in conjunction with the method.

### BRIEF DESCRIPTION OF THE DRAWINGS

FIG. 1 is a high-level flow chart describing a representative embodiment of a method for identifying the source of an instability in accordance with the disclosed subject matter.

FIG. 2 is a flow chart describing a representative embodiment of a method for detecting an instability in a furnace using multiple channels of data in accordance with the disclosed subject matter.

FIG. 3 is a graph showing the draft pressure measured by five pressure sensors over time as a flame is driven from a stable condition or phase to an unstable condition or phase and approaches blowoff.

FIG. 4 is a series of processed video frames showing the flames of three burners over time with background removed. The flames of the three burners are viewed from the top at a 45° angle. The video frame rate for the video frames in FIG. 4 is around 6.4 frames per second which, with the oscillation cycle spanning 11 frames, leads to an approximately 1.72 second oscillation cycle, or equivalently 0.58 Hz peak frequency.

FIG. 5 is a flow chart describing a representative embodiment of a method for converting a series of video frames into a scalar time series signal in accordance with the disclosed subject matter.

FIG. 6 is a graph of a scalar time series calculated based on a series of video frames in accordance with the disclosed subject matter.

FIG. 7 is a flow chart describing a representative embodiment of a method for processing two sets of measurements having different sampling rates into a combined set of measurements in accordance with the disclosed subject matter.

FIG. 8 is a flow chart describing a representative method for calculating the unstable signal component representation in accordance with the disclosed subject matter.

FIG. 9 is a flow chart describing a representative method for computing a detection test statistic in accordance with the disclosed subject matter.

FIG. 10 is a graph showing a comparison of the detection rate for an instability indicator in accordance with the disclosed subject matter against the detection rate for an instability detector based on the variance of pressure measurements from a single channel for a given false positive rate.

FIG. 11 is a graph showing a representative embodiment of the system for detecting an instability using a multi-channel approach in accordance with the disclosed subject matter.

FIG. 12 is a flow chart showing a representative embodiment of a method for identifying an unstable subset of burners in accordance with the disclosed subject matter.

FIG. 13 is a flow chart showing a representative embodiment of a method for identifying an unstable subset of burners based on the unstable signal matrix in accordance with the disclosed subject matter.

FIG. 14 is a graph showing two instances of clustering on a unit ball in accordance with the disclosed subject matter.

FIG. 15 is an illustration of a representative system for identifying an unstable subset of burners in accordance with the disclosed subject matter.

### DETAILED DESCRIPTIONS OF THE PREFERRED EMBODIMENTS

### Overview

Generally, the disclosed subject matter is directed to a method of detecting an instability in a furnace having a plurality of burners, the method comprising obtaining from each of a plurality of detectors a first measurement related to the plurality of burners when the furnace is operating in a stable condition, determining, based at least in part on the first measurement from each of the plurality of detectors, a stable signal component representation for the furnace, obtaining from each of the plurality of detectors a second measurement related to the plurality of burners when the furnace is operating in an unknown state, determining, based at least in part on the second measurement from each of the plurality of detectors and the stable signal component representation, an unstable signal component representation for the furnace, and detecting, using at least one processor, an instability in the furnace based at least in part on the unstable signal component representation and an instability threshold. Additionally, a system is provided herein. The system generally includes a plurality of detectors, and at least one processor coupled to the plurality of detectors and configured to obtain from each of the plurality of detectors a first measurement related to a plurality of burners when the furnace is operating in a stable condition, determine, based at least in part on the first measurements from each of the plurality of detectors, a stable signal component representation for the furnace, obtain from each of the plurality of detectors a second measurement related to the plurality of burners when the furnace is operating in an unknown state, determine, based at least in part on the second measurement from each of the plurality of detectors and the stable signal component representation, an unstable signal component representation for the furnace, and detect an instability in the furnace based at least in part on the unstable signal component representation and an instability threshold.

In accordance with another aspect, the disclosed subject matter is generally directed to a method of identifying, in a furnace having a plurality of burners, an unstable subset of burners from among the plurality of burners, the method comprising obtaining at least one measurement from each of a plurality of detectors, detecting an instability associated with the furnace, computing, using at least one processor, an unstable signal matrix associated with the instability based on the at least one measurement from each of the plurality of burners, and identifying the unstable subset of burners based at least in part on the unstable signal matrix. Additionally, a system is provided herein. The system generally includes a plurality of detectors and a processor coupled to the plurality of burners and configured to obtain at least one measurement from each of the plurality of detectors, detect an instability associated with the furnace, compute an unstable signal matrix associated with the instability based on the at least one measurement from each of the plurality of burners, and identify the unstable subset of burners based at least in part on the unstable signal matrix.

Reference will now be made in detail to representative embodiments of the disclosed subject matter, examples of which are illustrated in the accompanying drawings. The methods and systems disclosed herein will be described in conjunction with each other for clarity.

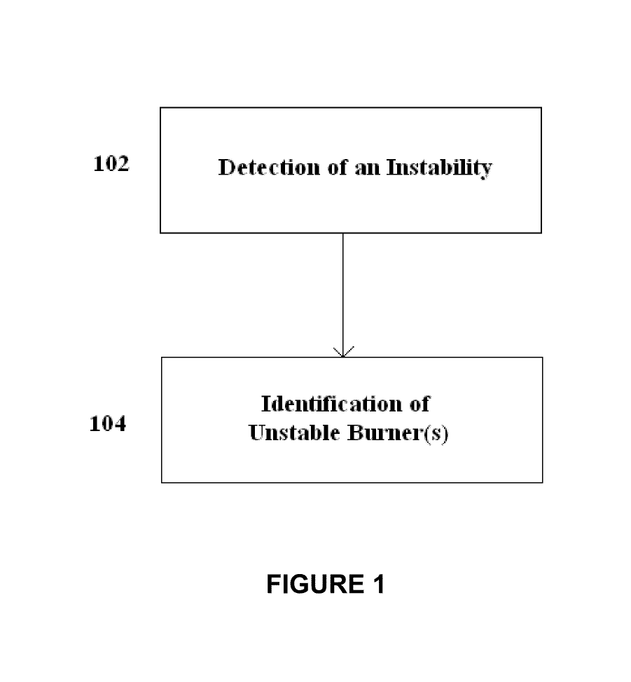

With reference to FIG. 1, a process for identifying an unstable subset of burners in a furnace comprising a plurality of burners is shown. First, a method is provided for detection of an instability (See 102). Subsequently, a method is provided for identifying the unstable subset of burners (See 104). Further details about these methods will be described herein.

Although these methods will generally be described herein in conjunction with each other, either of these methods can be used independently. For example, a system can detect an instability in accordance with the disclosed subject matter without thereafter proceeding to the identification of an unstable subset of burners. Similarly, a method for identifying an unstable subset of burners in accordance with the disclosed subject matter can be used regardless of how the instability is detected.

### DEFINITIONS

In the discussion herein, the phrase “subset of burners” refers to any number of burners that is less than the total number of burners associated with a furnace. The term “subset of burners” therefore can reference a single burner, or the term “subset of burners” can refer to two or more burners that are unstable. Furthermore, the term “subset of burners” can refer to a group of any number of burners, wherein at least one burner is unstable (i.e., one or more burners of the subset can be stable). Additionally, the system and methods disclosed herein may identify a subset of burners in accordance with this final embodiment when there are more burners than detectors.

In the discussed herein, the term “coupled” means operatively in communication with each other, either directly or indirectly, using any suitable techniques, including hard wire, connectors, or remote communication.

### Detecting an Instability

Although the disclosed subject matter is not limited to any particular theory of operation, a pressure signal at sensor p at time n can be modeled as:

xₚ[n]=x_{s,p}[n]+δxₚ[n] (1)

wherein x_{s,p}[n] is the stable pressure component for sensor p and δxₚ[n] is the unstable signal component for sensor p. It is observed that stable combustion generates more or less random variations (for example, in a pressure measurement). In contrast, flame instability is typically coherent, as manifested by harmonic pressure oscillations.

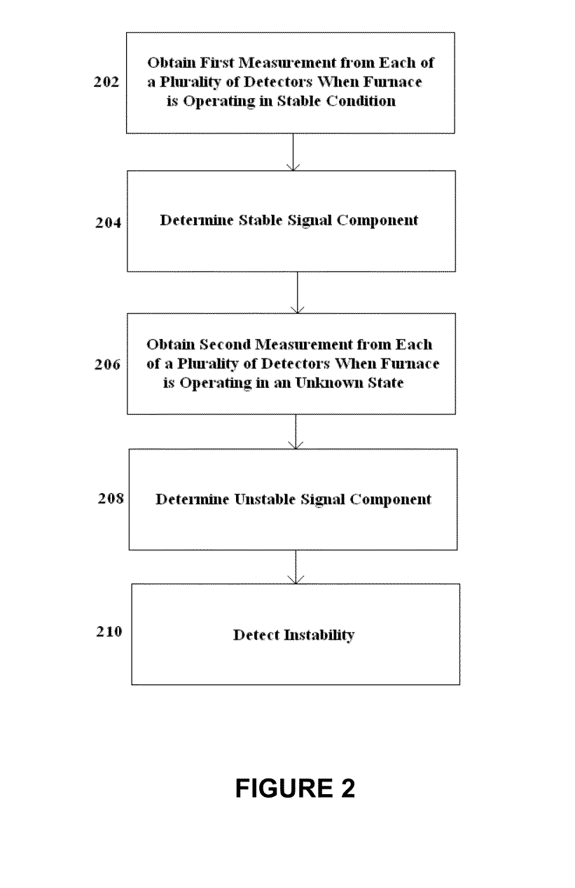

With further reference to FIG. 1, an instability is detected. (See 102). With reference to FIG. 2, an exemplary method of detecting an instability in a furnace having a plurality of burners in accordance with the disclosed subject matter is shown. First, the system obtains from each of a plurality of detectors a first measurement related to the plurality of burners when the furnace is operating in a stable condition. (See 202). The signals from the detector are then processed by a processor as described further below.

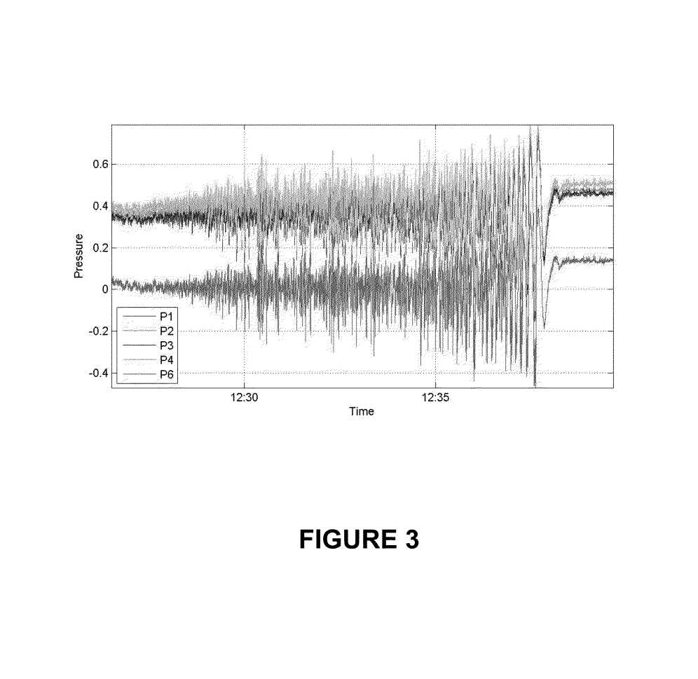

In one embodiment, each of the plurality of detectors is a pressure sensor. The pressure sensor can be, for example, a dynamic pressure sensor, such as a pressure probe, that can capture a high frequency signal. Each of the pressure sensors can measure the draft pressure at a single point inside a furnace. FIG. 3 illustrates an exemplary draft pressure measurement at five pressure sensors, P1-P4 and P6, as a function of time as the flames at each of the plurality of burners gradually approach blowoff.

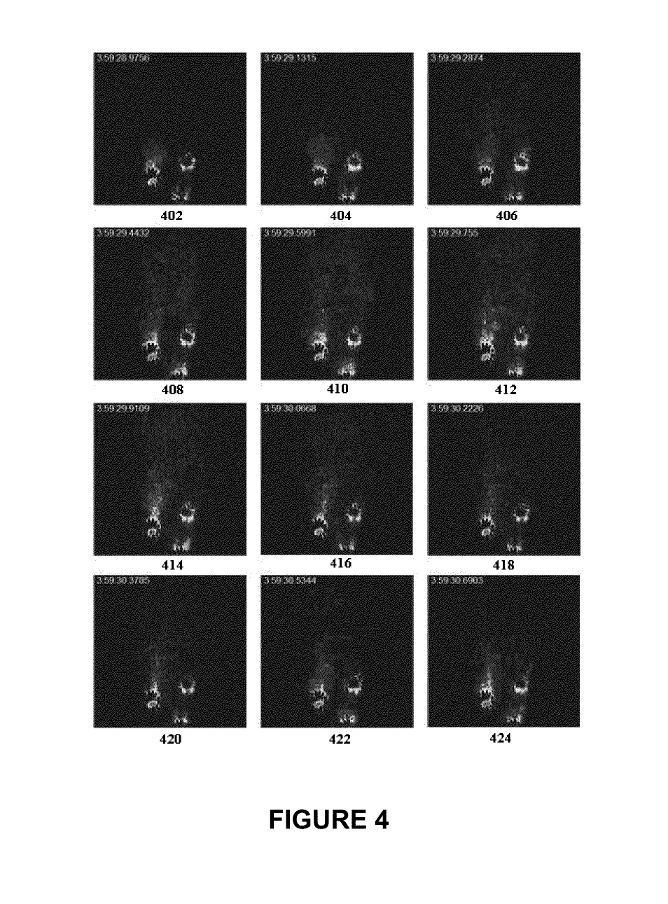

In another embodiment, each of the plurality of detectors is a device that captures video frames. The device can be, for example, a video camera. With reference to FIG. 4, the detector captures video frames 402-424. Each of the video frames in FIG. 4 shows the flames associated with three burners at various times.

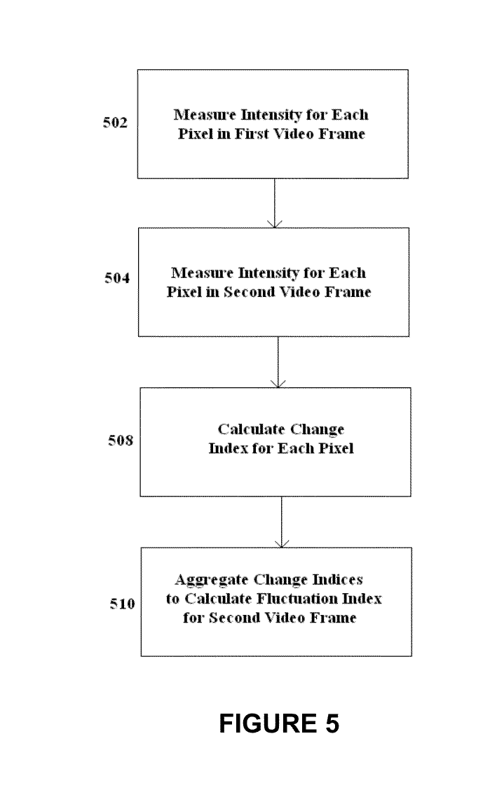

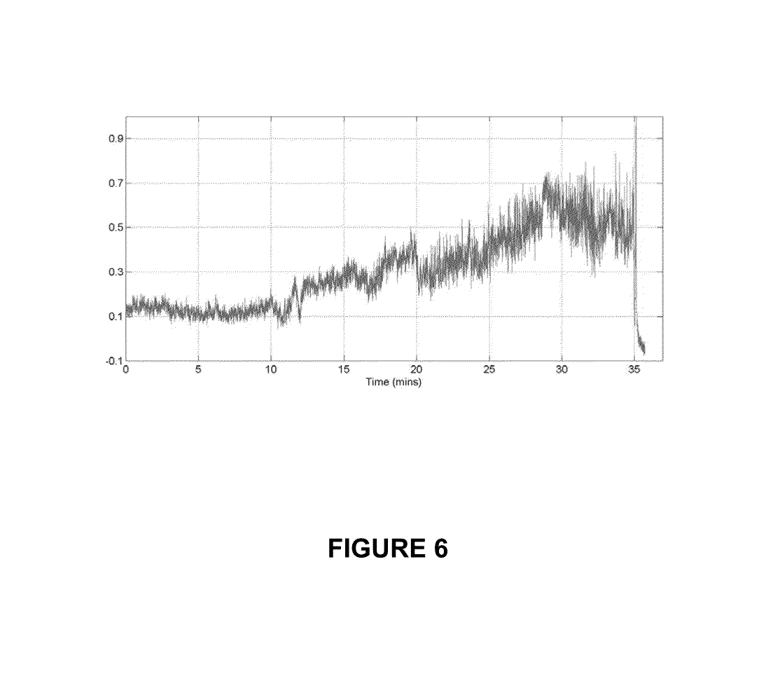

In order to determine a stable signal component representation for the furnace, the series of video frames from each device must be converted into a scalar time series signal, i.e., each video frame must be converted into a single value that can be plotted against time. Such pre-processing can be performed by the detector, by the processor, or by any intermediate device. In one embodiment, a video frame can be converted into a single value based on the intensity fluctuations associated with each pixel. For example, and with reference to FIG. 5, the intensity for each pixel in a first video frame (t=0) can be measured (See 502). The intensity for each pixel in a second video frame (t=1) can also be measured (See 504). The first video frame immediately precedes the second video frame (i.e., the first and second video frames are consecutive samples). For each pixel, a change index between the intensity in the first video frame and the intensity at the second video frame is calculated (See 508). The change index for each pixel is then aggregated to calculate a fluctuation index for the second video frame (See 510). The magnitude of the fluctuation index can then be plotted at time t=1 as part of the scalar time series signal. With reference to FIG. 6, a scalar time series signal obtained from a series of video frames at one device is shown.

In another embodiment, each of the plurality of detectors can be a vibration sensor. For example, the vibration sensor can be an accelerometer. The vibration sensor can be used to measure the oscillation of the furnace wall or piping.

Other detectors can also be used without departing from the scope of the disclosed subject matter. For example, optical sensors can be used to measure flicker. In other embodiments, detectors for measuring carbon dioxide or sulfur dioxide levels in the furnace can be used.

In accordance with one embodiment of the disclosed subject matter, the plurality of detectors can include one or more detectors of a first detector type and one or more detectors of a second detector type. Detectors of the first or second detector type can be pressure sensors, devices that capture video frames, vibration sensors, optical sensors, or sensors that measure carbon dioxide or sulfur dioxide levels.

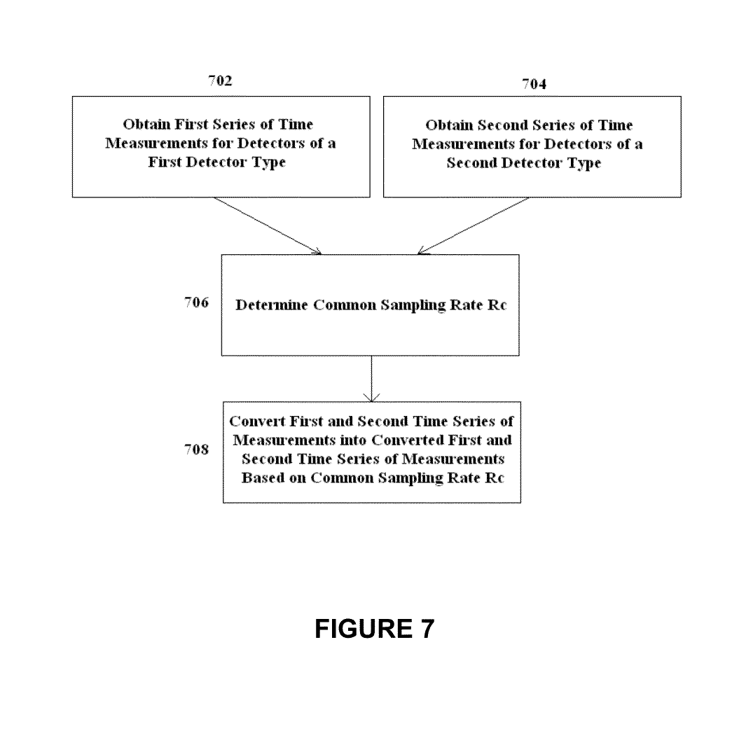

As known in the art, sensors generally measure some characteristic of an environment at regular intervals. The frequency of the measurements can be described in terms of the number of measurements taken over a given time period, or the sampling rate. For example, if Sensor A takes one measurement every second, the sampling rate of Sensor A is 1 per second, or 1 Hertz. In order to obtain the best results, each of the measurements should have a common sampling rate. If the detectors of a first detector type do not have the same sampling rate as detectors of a second detector type, one or both of the signals will need to be pre-processed. An exemplary pre-processing method in accordance with the disclosed subject matter is illustrated in FIG. 7.

A first series of time measurements is obtained from each of the one or more detectors of the first detector type (See 702). The detectors of the first detector type have a first sampling rate R1. Simultaneously, a second series of time measurements is obtained from each of the one or more detectors of the second detector type (See 704). The detectors of the second detector type have a second sampling rate R2.

The first time series of measurements and the second time series of measurements can be converted into a combined time series of measurements having a common sampling rate and a dynamic range. This conversion can include determining a common sampling rate and converting each of the first and second time series of measurements into a converted first and second time series of measurements based on the common sampling rate.

For example, and with further reference to FIG. 7, a common sampling rate Rc is determined (See 706). The common sampling rate can be determined based on any sampling techniques as known in the art. For example, the common sampling rate can be determined using Least Common Multiple-based upsampling when the first and second sampling rates are both low. Alternatively, the common sampling rate can be determined using Maximum Common Divisor-based downsampling when the first and second sampling rates are sufficiently high. The common sampling rate can be the first sampling rate R1. In another embodiment, the common sampling rate can be a sampling rate other than the first sampling rate and the second sampling rate. If the first sampling rate and the second sampling rate are the same (i.e., R1=R2), no upsampling or downsampling is needed.

Each of the first and second series of time series measurements is then converted into a converted times series of measurements based on the common sampling rate (See 708). If the common sampling rate is the first sampling rate R1, the first converted time series of measurements is the first time series of measurements. If the common sampling rate is a sampling rate other than the first sampling rate and the second sampling rate, both the first and second series of measurements will need to be converted.

While the upsampling or downsampling process described herein is described with reference to detectors of two or more types, it can also be used for detectors of a single type that do not have the same sampling rate.

With further reference to FIG. 2, a stable signal component representation for the furnace is determined based at least in part on the first measurement related to the plurality of burners. (See 204). In one embodiment, the stable signal component representation is a stable statistic. For example, the stable signal component representation can be a stable covariance matrix. The stable covariance matrix, Qₓₛ[m], at time m when the signal is known to be stable can be calculated as:

Qₓₛ[m]=Σ_{mεstableduration}(x[m]− x̅[m])(x[m]− x̅[m])^{t}/(M−1) (2)

where x[m] is the vector of sensor measurements at time m, x̅[m] is the mean of x[m] estimated at time m, (x[m]− X̅[m])^{t} is the transpose of the vector x[m]− x̅[m], and M is the length of the time window during which the stable covariance matrix is estimated.

With further reference to FIG. 2, the system later obtains from each of the plurality of detectors a second measurement related to the plurality of burners when the furnace is operating in an unknown state. (See 206).

An unstable signal component representation for the furnace is subsequently determined based at least in part on the second measurement from each of the plurality of detectors and the stable signal component representation. (See 208). As used herein, “unstable signal component” refers to the portion of the signal that is not attributed to the stable signal component, and does not denote that one or more of the burners in the furnace is necessarily unstable.

The unstable signal component representation can be an instability covariance matrix. The instability covariance matrix can be calculated based on the stable covariance matrix and a current covariance matrix. The current covariance matrix is a function of the second measurement from each of the plurality of detectors.

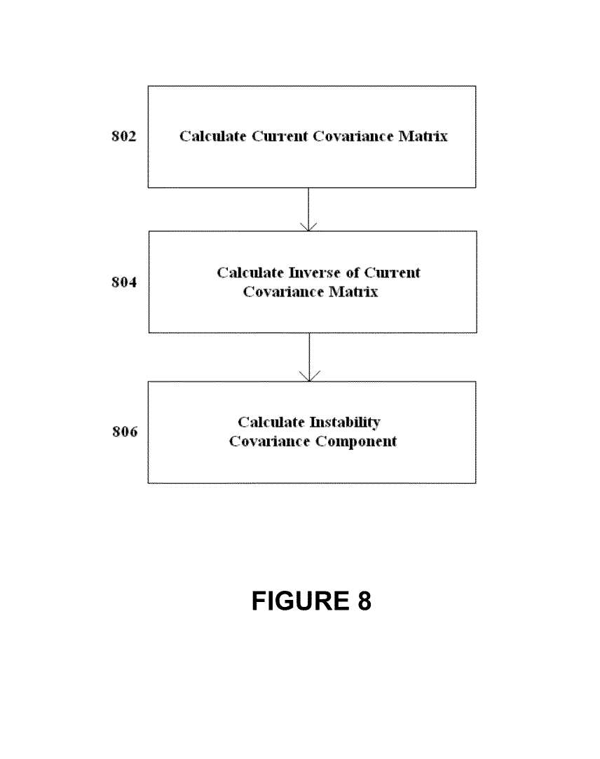

One embodiment of a method for calculating the unstable signal component representation in accordance with the disclosed subject matter is illustrated in FIG. 8. A current covariance matrix Qₓ[n] is calculated (See 802). In accordance with one embodiment of the disclosed subject matter, the current covariance matrix can be calculated as:

Qₓ[n]=λQₓ[n−1]+x[n]x[n]^{t} (3)

where λ is the forgetting factor taking a value between [0,1] such that past data is discounted at a rate of λ^{₀}^{-t}, Qₓ[n−1] is the current covariance matrix for the previous time period, x[n] is the vector of the second measurements from each of the plurality of detectors, and x[n]^{t} is the transpose of vector x[n].

With further reference to FIG. 8, the inverse of the current covariance matrix is calculated (See 804). For example, the inverse of the current covariance matrix Qₓ⁻¹[n] can be calculated using matrix inversion lemma:

Qₓ⁻¹[n]=λ⁻¹Qₓ⁻¹[n−1]λ⁻¹q[n]q[n]^{t}/(λ+x^{t}[n]q[n]) (4)

where

q[n]=Qₓ⁻¹[n−1]x[n] (5)

The instability covariance component representation is then calculated (See 806). In one embodiment, the instability covariance component representation can be calculated as:

Q_{δx}[n]=Qₓ[n]−Qₓₛ (6)

This calculation can be followed by a projection to ensure that the resulting instability covariance matrix is non-negative.

Finally, an instability in the furnace is detected based at least in part on the unstable signal component representation and an instability threshold (See 210). Generally, an instability will be detected when a detector, which can be based on the unstable signal component representation, exceeds the instability threshold.

In accordance with one embodiment of the disclosed subject matter, the instability threshold can be compared against a detection test statistic. The detection test statistic can be, for example, a Neyman-Pearson detector. The detection test statistic can be computed based on the inverse of a stable covariance matrix. In another embodiment, the detection test statistic can be computed based on the inverse of a current covariance matrix.

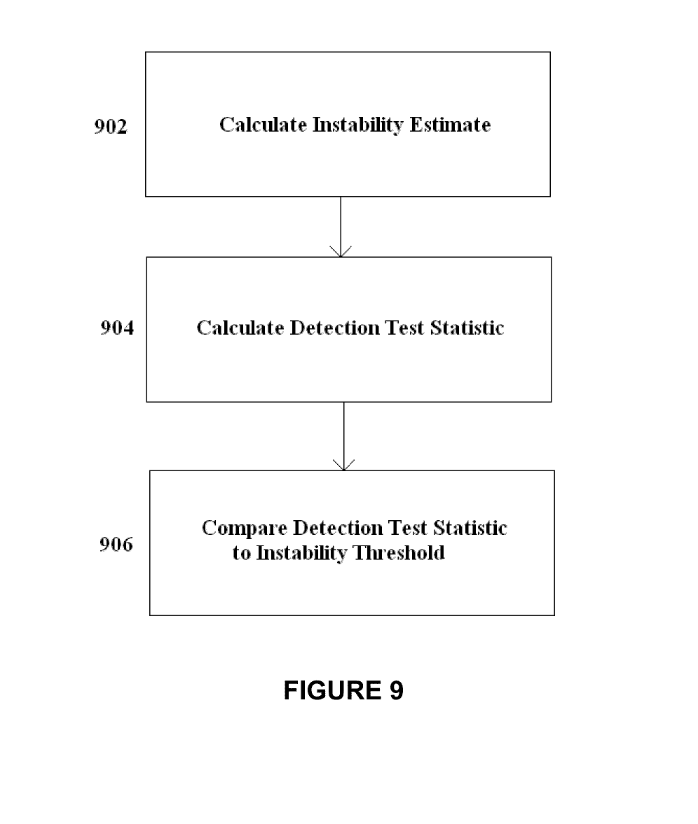

FIG. 9 illustrates one method of computing a detection test statistic in accordance with the disclosed subject matter. An instability estimate is calculated (See 902). The instability estimate can be calculated as the minimum mean squared error (MMSE) estimator \hat{δ}xₘₘₛₑ[n] of the instability signal δx:

\hat{δ}xₘₘₛₑ[n]=Q_{δx}Qₓ⁻¹x[n] (7)

A detection test statistic is then calculated based on the instability estimate (See 904). The detection test statistic can be based on the Neyman-Pearson detector. For example, the detection test statistic T(x[n]) can be calculated as:

$$T ( x [ n ] ) = x [ n ] {Q}_{x}^{- 1} \overline{δ} x + \frac{1}{2} {x [ n ]}^{t} {Q}_{xs}^{- 1} \hat{δ} {x}_{mmse} [ n ] \qquad ( 8 )$$

In cases where instability mainly consists of pressure oscillations, it can be assumed that the instability signal has zero-mean, i.e., δ̅x=0. Thus, Equation (8) can be simplified as:

$$T ( x [ n ] ) = \frac{1}{2} {x [ n ]}^{t} {Q}_{xs}^{- 1} \hat{δ} {x}_{mmse} [ n ] \qquad ( 9 )$$

In accordance with another embodiment of the disclosed subject matter, the detection test statistic can be calculated based solely on the instability estimate. For example, the detection test statistic can be calculated as the squared norm of the MMSE estimate of the instability signal:

T₁(x[n])=∥ δ̅xₘₘₛₑ[n]∥₂ (10)

In the presence of an instability, it can be shown that

E{T₁(x[n])}=tr(Q_{δx}Qₓ⁻¹Q_{δx}) (11)

where tr(•) denotes matrix trace.

With further reference to FIG. 9, the detection test statistic is compared to the instability threshold (906). The threshold can be mathematically derived or based on experimental observations. The identification of the threshold can vary based on several variables, including the types of detector(s) utilized to obtain the signal, the desired target detection probability, the false positive rate, and the detection delay. For example, if it is desired to minimize the false positive rate (e.g., because incorrect detection of an instability is economically inefficient), the threshold can be raised and the detection delay will increase.

In accordance with one embodiment of the disclosed subject matter, the instability threshold γ for a Neyman-Pearson detector is calculated as:

$${P}_{fa} = {\int }_{x \text{:} L ( x ) > γ}^{ } p ( x ; {H}_{0} ) d x = α \qquad ( 12 )$$

where p_{fa}=α is a given false positive alarm rate, L(x) is the probability that the signal is unstable given a vector x divided by the probability that the signal is stable given the vector x, and p(x; H₀) is the probability that the signal is stable given the vector x.

If the detection test statistic exceeds the threshold, then an instability can be detected. In accordance with another embodiment, for example, an instability can be detected only if the detection test statistic has exceeded the instability threshold for a predetermined number of samples in a row. If the detection test statistic exceeds the instability threshold, but this has occurred for fewer than the predetermined number of samples in a row, a count variable can be incremented.

If the detection statistic does not exceed the threshold, an instability is not detected. If present, a count variable can be reset to zero. In addition, the stable signal component can be reset as:

Qₓₛ[n]=λQₓₛ[n−1]+x[n]x[n]^{t} (13)

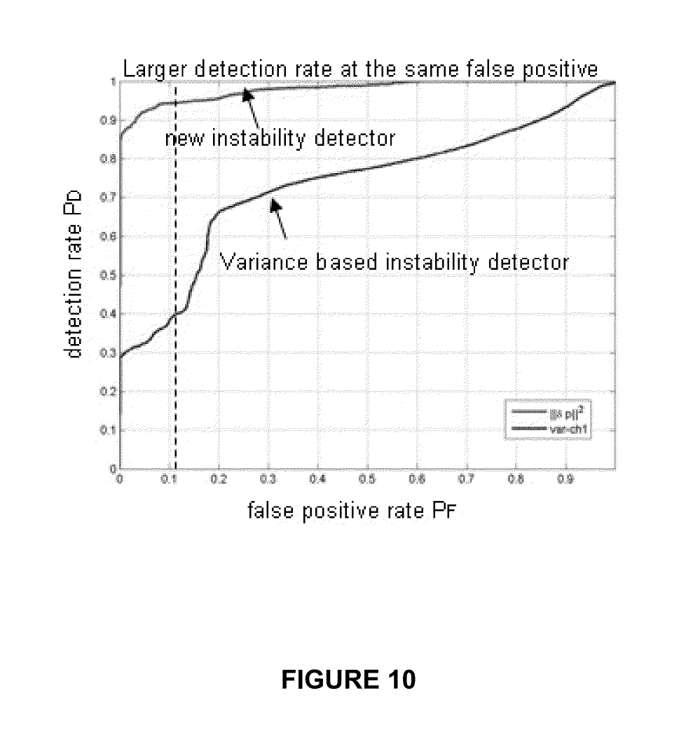

The use of multiple channels of data can significantly improve the output signal to noise ratio (SNR). Generally, the output signal to noise ratio of a coherent processor is understood to increase linearly with the number of channels. The improved SNR, in turn can, improve detection performance in the sense that given a fixed false positive rate, the multi-channel detector can achieve higher detection probability or a shorter detection delay than a detector with lower output SNR. For example, FIG. 10 illustrates a comparison between an instability detector in accordance with the disclosed subject matter (top line in FIG. 10) and an instability detector based on the variance of pressure measurements from a single channel (bottom line in FIG. 10), both of which are based on the same set of measurement data. The instability detector in accordance with the disclosed subject matter corresponds to the detection test statistic T₁(x[n]) as described herein. As shown, the detection test statistic T₁(x[n]) method of invention (top line in FIG. 10) has a better detection rate for a given false positive rate than the variance-based instability detector (bottom line in FIG. 10).

An alarm can be provided when an instability is detected. The alarm can be, for example, an audio alarm such as a siren or a visual alarm such as a flashing light or an indication on the monitor of a computer screen. More generally, any method of informing an operator that an instability has been detected can be used as known in the art for its intended purpose.

Corrective action can also be taken when an instability is detected. For example, the furnace can be shut down, which can prevent an explosion and allow repairs and/or maintenance to be provided to the furnace. In another embodiment, an operating property of the furnace can be adjusted. For example, the amount of steam injected into the furnace can be decreased until the instability is resolved.

### Instability Detection System

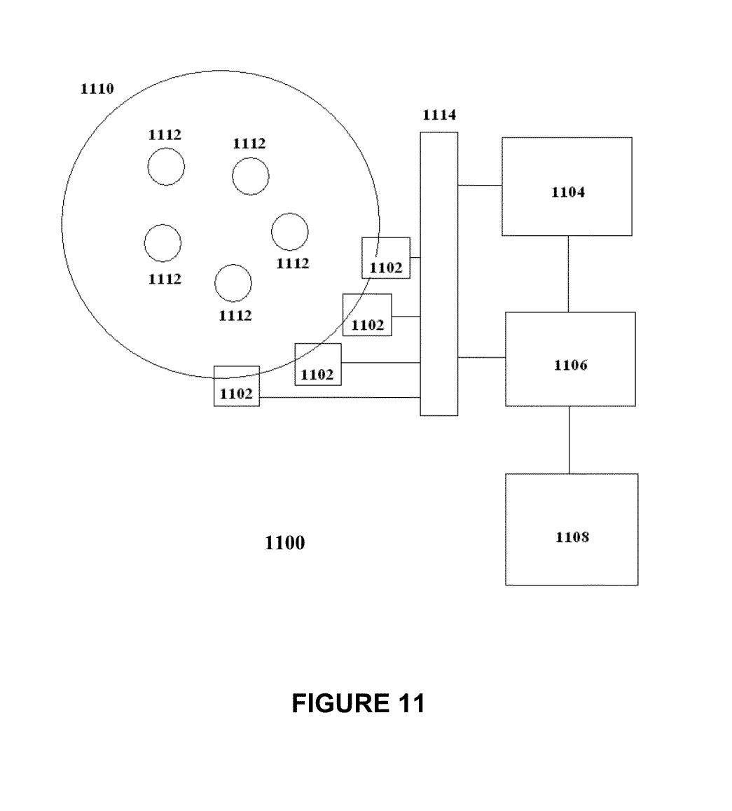

As previously noted, the disclosed subject matter further includes a system for multi-channel detection of an instability. For purpose of explanation and illustration, and not limitation, an exemplary embodiment of the system for detecting an instability using multiple data channels in accordance with the disclosed subject matter is shown in FIG. 11. The instability detection system 1100 can include a plurality of detectors 1102, a stable signal component processing unit 1104, an unstable signal component processing unit 1106, and an instability detection unit 1108.

Each of the plurality of detectors 1102 is disposed within or near a furnace 1110. The detectors 1102 are disposed to measure the characteristic of interest. For example, the detectors 1102 can be disposed within the furnace 1110 (e.g., in the case of a pressure sensor) or outside of the furnace 1110 (e.g., in the case of a video camera for recording the flame) as desired and suitable.

The stable signal detection processing unit 1104 is coupled to the detectors 1102 and configured to receive a first measurement from each of the plurality of detectors 1102 during stable combustion and determine a stable signal component representation of the furnace 1110 based on the first measurement from each of the plurality of detectors 1102. For purposes of illustration, each of the detectors 1102 can optionally be coupled via suitable wiring or other transmission device 1114 to the stable signal detection processing unit 1104. However, any component can be coupled to any other component either directly or indirectly through other components.

The unstable signal component processing unit 1106 is coupled to the detectors 1102 and the stable signal component processing unit 1104. The unstable signal component processing unit 1106 is configured to receive a second measurement from each of the plurality of the detectors 1102 when the furnace is operating in an unknown state and determine an unstable signal component representation of the furnace 1110 based on the stable signal component representation and the second measurement received from each of the plurality of detectors 1102.

The instability detection unit 1108 is coupled to the unstable signal component processing unit 1106 and is configured to detect an instability in the furnace based at least in part on the unstable signal component representation and an instability threshold. The instability detection unit can include a detection test statistic generator that is configured to determine a detection test statistic as discussed herein. Additional functional units can be used to perform other functions of the method as disclosed herein.

The stable signal component processing unit 1104, the unstable signal component processing unit 1106, the instability detection unit 1108, the detection test statistic generator, and other functional units of the instability detection system 1100 can be implemented in a variety of ways as known in the art. For example, each of the functional units can be implemented using an integrated single processor. Alternatively, each functional unit can be implemented on a separate processor. Therefore, the instability detection system 1100 can be implemented using at least one processor and/or one or more processors.

The at least one processor comprises one or more circuits. The one or more circuits can be designed so as to implement the disclosed subject matter using hardware only. Alternatively, the processor can be designed to carry out the instructions specified by computer code stored in a hard drive, a removable storage medium, or any other storage media. Such non-transitory computer readable media can store instructions that, upon execution, cause the at least one processor to perform the methods as disclosed herein.

Continuing with FIG. 11, the furnace 1110 includes a plurality of burners 1112. The term “furnace,” as used herein, refers to a wide variety of equipment that includes at least one burner, including, for example, industrial furnaces, fired heaters, and boilers. The furnace 1110 can be located at a refinery or similar location. Each of the plurality of burners 1112 or another functional element of the furnace 1110 (e.g., a steam injector) can be coupled to the instability detection unit 1108 and a corrective action processor in order to automatically institute a corrective action when an instability is detected. The corrective action processor can include one or more processors comprising one or more circuits as discussed above.

The instability detection system 1100 can further include additional components in accordance with the disclosed subject matter. For example, the system can include an alarm coupled to the instability detector that is activated when an instability is detected. The alarm can be, for example, a siren, a flashing light, an alarm on a computer console (preferred a manned distributed control console), or any other alarm.

### Identification of Unstable Burner(s)

In furnaces with a large number of burners, an instability caused by one burner can have significant impact on the operation of the furnace and system as a whole. For example, one unstable burner can require that an entire furnace be shut down when all of the other burners are stable. This is both environmentally and economically inefficient. Moreover, once that furnace has been shut down, it may take an extended period of time to investigate which burner is responsible for the instability. In the event of an inconclusive investigation, the operator may replace one or more burners based on his or her best judgment. This “best judgment” replacement strategy can be both costly and ineffective.

The disclosed subject matter therefore provides systems and methods for identifying an unstable subset of burners. Generally, the method disclosed herein includes obtaining at least one measurement from each of a plurality of detectors, detecting an instability associated with the furnace, computing, using at least one processor, an unstable signal matrix associated with the instability based on the at least one measurement from each of the plurality of burners, and identifying the unstable subset of burners based at least in part on the unstable signal matrix.

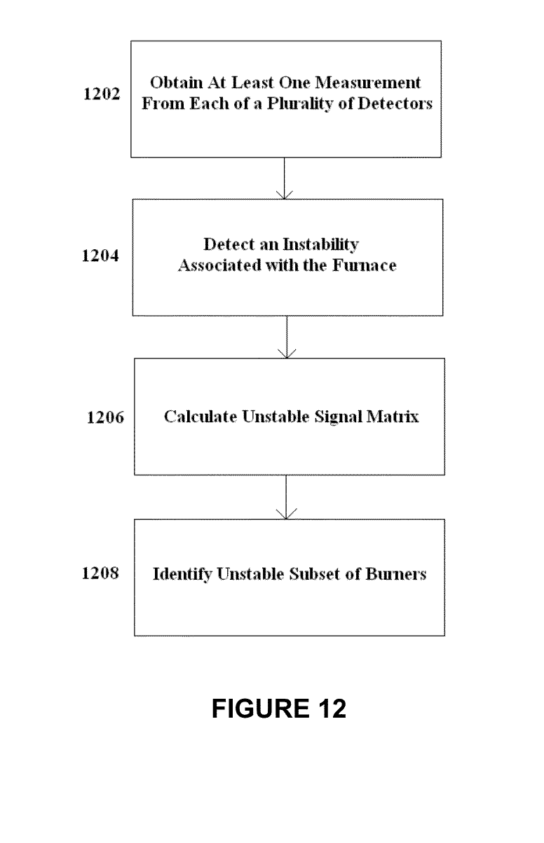

One embodiment of identifying the unstable subset of burners in accordance with the disclosed subject matter is illustrated in FIG. 12.

First, at least one measurement is obtained from each of a plurality of detectors (See 1202). A wide variety of detectors can be used as previously described herein with reference to the disclosed system and method for detecting an instability.

An instability associated with the furnace is then detected (See 1204). In accordance with one embodiment of the disclosed subject matter, the instability can be detected as discussed above with reference to, for example, the method of FIG. 2 as previously described in detail. However, the method for identifying an unstable subset of burners in accordance to the disclosed subject matter is not limited to such embodiment. Other instability detection systems can also be used as known and suitable for their intended purpose. For example, a variance-based instability detector as discussed and illustrated with regard to FIG. 10 can be used to detect an instability.

An unstable signal matrix associated with the instability can be calculated based on the at least one measurement from each of the plurality of burners (See 1206). The unstable signal matrix can be the instability component covariance as previously discussed herein with reference to FIG. 8.

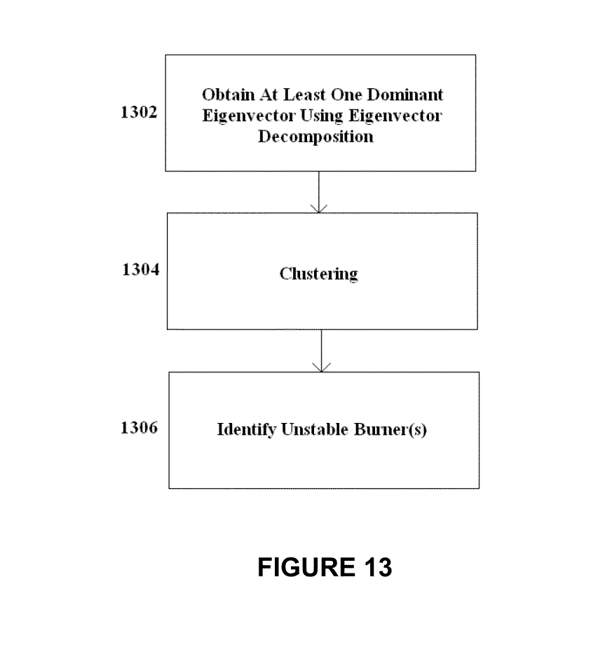

Finally, the unstable subset of burners can be identified based at least in part on the unstable signal matrix (See 1208). One embodiment of the method for identifying the unstable subset of burners based on the unstable signal matrix in accordance with the disclosed subject matter is illustrated in FIG. 13.

With reference to FIG. 13, the at least one dominant eigenvector of the unstable signal matrix is obtained using eigenvalue decomposition (See 1302). The method for obtaining an eigenvector is well known in the art, and can be represented as:

[V,D]=eig(Q_{δx}[n]) (14)

where D represents the dominant eigenvalues and V represents the associated eigenvectors. In the case of a single unstable burner, the Greens function vector \tilde{g}ₘ, which relates to the mapping from the unstable burner(s) to the plurality of sensors, can be recovered from the first dominant eigenvector of Q_{δx}[n]:

\tilde{g}ₘ=αV(:,1) (15)

where α is a scaling factor that normalizes the Greens function and V(:,1) is the first dominant eigenvector. The principle of linear superposition applies in the case of multiple unstable burners. Thus, the dominant eigenvector is directly correlated to the Green's function vector and can be used to identify the unstable subset of burners.

The length of the eigenvectors will depend on the number of sensors deployed in the furnace and used in the calculation of the unstable signal matrix. For example, in a furnace with three pressure sensors, the eigenvector will be 3×1.

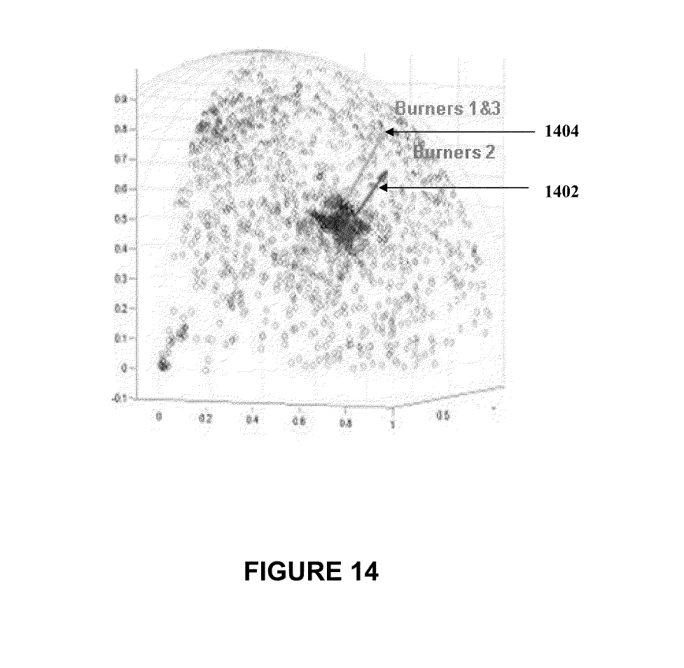

With further reference to FIG. 13, clustering (See 1304) is performed based on the dominant eigenvector. Clustering generally refers to grouping data recovered from the current dominant eigenvector and a plurality of previous dominant eigenvectors. For example, in one embodiment the furnace has three detectors. As discussed above, the resulting eigenvector will be 3×1. The three components of this eigenvector define a point on a unit ball. An exemplary embodiment of a unit ball in accordance with the disclosed subject matter is illustrated in FIG. 14. The point corresponding to the three components of the eigenvector can be plotted on the unit ball along with points corresponding to the three components of the plurality of previous eigenvectors.

More generally, while the first dominant eigenvector represents a combined effect of all unstable burners, other eigenvectors may also contain information that is useful for burner identification. In such case, the unit ball concept can easily be generalized to a higher dimensional clustering with additional eigenvectors as feature vectors. Although visualization in the higher dimensional space is not as intuitive as in the unit ball with three dimensions, the clustering technique is fundamentally the same.

As previously noted, it has been observed that stable combustion produces random fluctuations. As such, the mapping associated with the instability during stable combustion, and therefore the point associated with the dominant eigenvector during stable combustion, will be random. However, if at least one of the burners is unstable, the resulting points will still vary, but will generally group around the point related to the mapping between the unstable burner(s) and the plurality of detectors, because all other fluctuations will be random. Thus, the points plotted on a unit ball will tend to cluster in the presence of an instability.

With further reference to FIG. 13, the subset of burners associated with the instability are identified (See 1306) based on the clustering. Additional information can be used to interpret the results of the clustering. For example, the locations of the burners and the pressure sensors can be used to constrain the Greens function. The signal frequency can likewise be used to constrain the signal function. Trial and error can also be used to assist in the interpretation of the clustering.

For example, with further reference to FIG. 14, the results of two instances of clustering are shown. Each instance of clustering can be interpreted to produce a resulting vector. For example, the first instance of clustering can result in vector 1402, while the second instance of clustering can result in vector 1404. Based on experimental data and the locations of the burners and sensors, vector 1402 corresponds to the identification of Burner 2 as the unstable burner. Vector 1404 corresponds to the identification of Burners 1 and 3 as the unstable burners.

The identification of one or more unstable burners allows the operator of the furnace additional options when the instability is detected. For example, the operator can choose to deactivate the unstable burner(s) rather than shutting down the furnace as a whole. This process can also be automated such that the unstable burner is automatically deactivated when the system identifies the source of the instability.

This identification also allows repairs to be made to the furnace in a timely manner, minimizing the inactivity period of the furnace.

### Unstable Burner Identification System

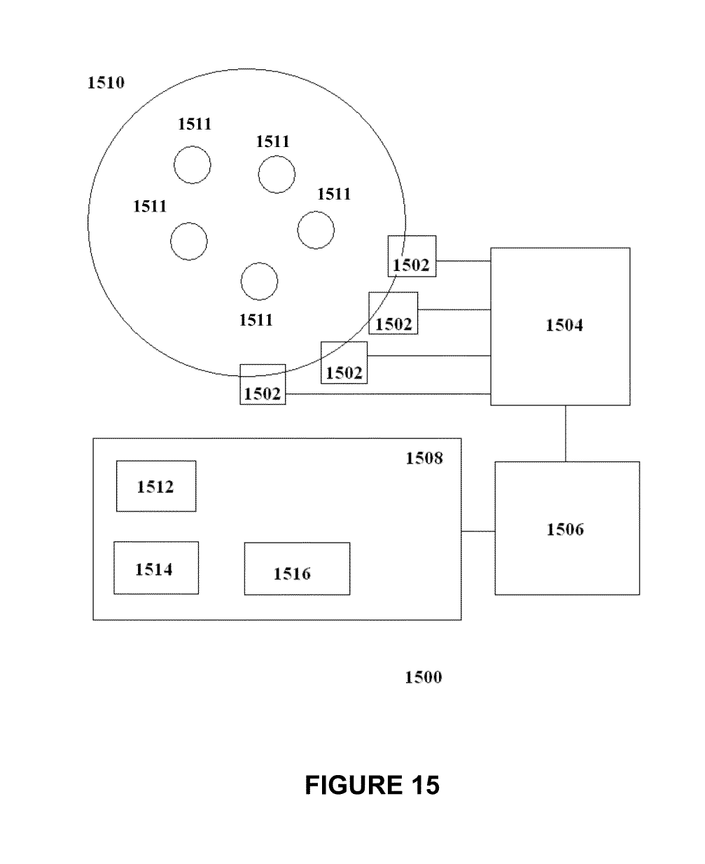

For purpose of explanation and illustration, and not limitation, an exemplary embodiment of the system for identifying a subset of unstable burners in accordance with the application is shown in FIG. 15. The unstable burner identification system 1500 can include a plurality of detectors 1502, an instability detection unit 1504, an unstable matrix computation unit 1506, and an unstable burner identifier 1508.

The plurality of detectors 1502 can include any detectors as discussed above with reference to the detectors 1102 in FIG. 11, and do not require further explanation.

The instability detection unit 1504 is coupled to the detectors 1502 and is configured to detect an instability associated with the furnace 1510 comprising a multitude of burners 1511. The instability detection unit 1504 can include the stable signal component processing unit 1104, the unstable signal component processing unit 1106, and the instability detection unit 1108 of FIG. 11. However, the instability detection unit 1504 of the unstable burner identification system 1500 is not limited to such embodiments. In general, the instability detection unit 1504 can be any system for detecting an instability associated with a furnace. For example, the instability detection unit 1504 can be a system that implements a variance-based detection approach and identifies an instability based on a variance-based instability indicator such as instability indicator described and illustrated in FIG. 10.

The unstable matrix computation unit 1506 is coupled to the detectors 1502 and the instability detection unit 1504. The unstable matrix computation unit 1506 is configured to compute an unstable signal matrix associated with the instability based on at least one measurement from each of the plurality of burners.

The unstable burner identifier 1508 is coupled to the unstable matrix computation unit 1506 and is configured to identify an unstable subset of burners based at least in part on the unstable signal matrix. The unstable burner identifier can include an eigenvalue decomposer 1512 that is configured to perform eigenvalue decomposition of the unstable signal matrix to obtain at least one dominant eigenvector, a clusterer 1514 configured to cluster data obtained from the dominant eigenvector with data obtained from a plurality of previous eigenvectors, and an interpretation unit 1516 configured to interpret the cluster data and identify one or more unstable burners.

Additional functional units can be used to perform other functions of the method as disclosed herein.

The instability detection unit 1504, the unstable matrix computation unit 1506, the unstable burner identifier 1508, the eigenvalue decomposer 1512, the clusterer 1514, the interpretation unit 1516, and other functional units of the unstable burner identification system 1500 can be implemented in a variety of ways as known in the art. For example, each of the functional units can be implemented using an integrated single processor. Alternatively, the each functional unit can be implemented on a separate processor. Therefore, the unstable burner identification system 1500 can be implemented using at least one processor and/or one or more processors.

The at least one processor comprises one or more circuits. The one or more circuits can be designed so as to implement the disclosed subject matter using hardware only. Alternatively, the processor can be designed to carry out the instructions specified by computer code stored in a hard drive, a removable storage medium, or any other storage media. Such non-transitory computer readable media can store instructions that, upon execution, cause the at least one processor to perform the methods as disclosed herein.

The unstable burner identification system 1500 can further include additional components in accordance with the disclosed subject matter. For example, the system can include an alarm coupled to the instability detector that is activated when an instability is detected. The alarm can be, for example, a siren, a flashing light, or any other alarm.

### ADDITIONAL EMBODIMENTS

Additionally or alternately, the invention can include one or more of the following embodiments

### Embodiment 1

A method for detecting an instability in a furnace having a plurality of burners, the method comprising obtaining from each of a plurality of detectors a first measurement related to the plurality of burners when the furnace is operating in a stable condition, determining, based at least in part on the first measurement from each of the plurality of detectors, a stable signal component representation for the furnace, obtaining from each of the plurality of detectors a second measurement related to the plurality of burners when the furnace is operating in an unknown state, determining, based at least in part on the second measurement from each of the plurality of detectors and the stable signal component representation, an unstable signal component representation for the furnace, and detecting, using at least one processor, an instability in the furnace based at least in part on the unstable signal component representation and an instability threshold.

### Embodiment 2

The method of Embodiment 1, wherein the plurality of detectors comprises a plurality of pressure sensors.

### Embodiment 3

The method of any of the foregoing Embodiments, wherein the plurality of detectors comprises a plurality of vibration sensors.

### Embodiment 4

The method of any of the foregoing Embodiments, wherein the plurality of detectors comprises a plurality of video sensors.

### Embodiment 5

The method of any of the foregoing Embodiments, wherein the stable signal component representation for the furnace comprises a stable covariance matrix.

### Embodiment 6

The method of any of the foregoing Embodiments, wherein the unstable signal component representation for the furnace comprises an instability component covariance.

### Embodiment 7

The method of Embodiment 6, wherein the instability component covariance is calculated based on a stable covariance matrix and a current covariance matrix.

### Embodiment 8

The method of Embodiment 7, wherein the current covariance matrix is calculated based on the stable component covariance matrix and a vector of the second measurement from each of the plurality of burners.

### Embodiment 9

The method of any of the foregoing Embodiments, wherein the instability threshold is compared against a detection test statistic.

### Embodiment 10

The method of Embodiment 9, wherein the detection test statistic comprises a Neyman-Pearson detector.

### Embodiment 11

The method of Embodiments 9 or 10, further comprising computing the detection test statistic based on an inverse of a stable covariance matrix.

### Embodiment 12

The method of Embodiments 9 or 10, further comprising computing the detection test statistic based on an inverse of a current covariance matrix.

### Embodiment 13

The method of Embodiment 12, wherein the inverse of the current covariance matrix is computed via matrix inversion lemma.

### Embodiment 14

The method of any of the foregoing Embodiments, wherein the plurality of detectors comprise one or more detectors of a first detector type and one or more detectors of a second detector type.

### Embodiment 15

The method of Embodiment 14, wherein obtaining the first measurement comprises obtaining a first time series of measurements from each of one or more detectors of a first detector type the first time series of measurements from each of the one or more detectors of a first detector type having a first sampling rate, and obtaining a second time series of measurements from each of the one or more detectors of a second detector type, the second time series of measurements from each of the one or more detectors of a second detector type having a second sampling rate.

### Embodiment 16

The method of Embodiment 15, wherein the first time series of measurements includes the first measurement for each of the one or more detectors of a first detector type, and wherein the second time series of measurements includes the first measurement for each of the one or more detectors of a second detector type.

### Embodiment 17

The method of Embodiments 15 or 16, further comprising converting the first time series of measurements and the second time series of measurements into a combined time series of measurements having a common sampling rate.

### Embodiment 18

The method of Embodiment 17, wherein determining the stable signal component representation for the furnace comprises determining the stable signal component for the furnace based at least in part on the combined time series of measurements.

### Embodiment 19

The method of Embodiments 17 or 18, wherein the common sampling rate comprises the first sampling rate.

### Embodiment 20

The method of Embodiments 17 or 18, wherein the common sampling rate is a sampling rate other than the first sampling rate and the second sampling rate.

### Embodiment 21

The method of any of Embodiments 15 through 20, wherein the first time series of measurements includes the second measurement for each of the one or more detectors of a first detector type, and wherein the second time series of measurements includes the second measurement for each of the one or more detectors of a second detector type.

### Embodiment 22

The method of Embodiment 21, wherein determining the unstable signal component for the furnace comprises determining the unstable signal component representation for the furnace based on the combined time series of measurements.

### Embodiment 23

The method of any of Embodiments 15 through 22, wherein the first time series of measurements comprises at least one video frame.

### Embodiment 24

The method of Embodiment 23, further comprising converting the at least one video frame into a single value.

### Embodiment 25

The method of Embodiment 24, wherein the at least one video frame is converted into a single value based at least in part on the intensity of each pixel in the at least one video frame.

### Embodiment 26

A method for identifying, in a furnace having a plurality of burners, an unstable subset of burners from among the plurality of burners, the method comprising obtaining at least one measurement from each of a plurality of detectors, detecting an instability associated with the furnace, computing, using at least one processor, an unstable signal matrix associated with the instability based on the at least one measurement from each of the plurality of burners, and identifying the unstable subset of burners based at least in part on the unstable signal matrix.

### Embodiment 27

The method of Embodiment 26, wherein detecting an instability associated with the furnace comprises any of Embodiments 1 through 25.

### Embodiment 28

The method of Embodiments 26 or 27, wherein the unstable signal matrix comprises an instability component covariance.

### Embodiment 29

The method of Embodiments 26, 27, or 28, further comprising using eigenvector decomposition of the unstable signal matrix to obtain at least one dominant eigenvector.

### Embodiment 30

The method of Embodiment 29, wherein the at least one dominant eigenvector includes three components defining a point on a unit ball.

### Embodiment 31

The method of Embodiment 30, further comprising clustering the point with a plurality of other points from a plurality of previous dominant eigenvectors.

### Embodiment 32

The method of Embodiment 31, further comprising identifying the unstable subsets of burners based on the clustering.

### Embodiment 33

The method of Embodiment 32, wherein historical data is used to identify the unstable subset of burners.

### Embodiment 34

The method of Embodiment 29, further comprising recovering a Green's function vector from the at least one dominant eigenvector.

### Embodiment 35

The method of Embodiment 34, wherein the at least one dominant eigenvector is normalized to obtain the Green's function vector.

### Embodiment 36

The method of any of Embodiments 26 through 35, wherein the unstable subset of burners comprises a single burner.

### Embodiment 37

The method of any of Embodiments 26 through 35, wherein the unstable subset of burners comprises a plurality of burners.

### Embodiment 38

The method of any of Embodiments 26 through 35, wherein the unstable subset of burners comprises a group of burners containing at least one unstable burner.

### Embodiment 39

A system for detecting an instability in a furnace having a plurality of burners, the system comprising a plurality of detectors, and at least one processor coupled to the plurality of detectors and configured to obtain from each of the plurality of detectors a first measurement related to a plurality of burners when the furnace is operating in a stable condition, determine, based at least in part on the first measurements from each of the plurality of detectors, a stable signal component representation for the furnace, obtain from each of the plurality of detectors a second measurement related to the plurality of burners when the furnace is operating in an unknown state, determine, based at least in part on the second measurement from each of the plurality of detectors and the stable signal component representation, an unstable signal component representation for the furnace, and detect an instability in the furnace based at least in part on the unstable signal component representation and an instability threshold.

### Embodiment 40

The system of Embodiment 39 configured to use in accordance with any of the methods described in Embodiments 1 through 25.

### Embodiment 41

A system for identifying, in a furnace having a plurality of burners, an unstable subset of burners from among the plurality of burners, the system comprising a plurality of detectors and a processor coupled to the plurality of burners and configured to obtain at least one measurement from each of the plurality of detectors, detect an instability associated with the furnace, compute an unstable signal matrix associated with the instability based on the at least one measurement from each of the plurality of burners, and identify the unstable subset of burners based at least in part on the unstable signal matrix.

### Embodiment 42

The system of Embodiment 41 configured for use in accordance with any of the methods described in Embodiments 26 through 38.

While the present application is described herein in terms of certain preferred embodiments, those skilled in the art will recognize that various modifications and improvements may be made to the application without departing from the scope thereof. Thus, it is intended that the present application include modifications and variations that are within the scope of the appended claims and their equivalents. Moreover, although individual features of one embodiment of the application may be discussed herein or shown in the drawings of one embodiment and not in other embodiments, it should be apparent that individual features of one embodiment may be combined with one or more features of another embodiment or features from a plurality of embodiments.

In addition to the specific embodiments claimed below, the application is also directed to other embodiments having any other possible combination of the dependent features claims below and those disclosed above. As such, the particular features presented in the dependent claims and disclosed above can be combined with each other in other manners within the scope of the application such that the application should be recognized as also specifically directed to other embodiments having any other possible combinations. Thus, the foregoing description of specific embodiments of the application has been presented for purposes of illustration and description. It is not intended to be exhaustive or to limit the application to those embodiments disclosed.

What is claimed is:

1. A method for detecting an instability in a furnace having a plurality of burners, the method comprising:
obtaining from each of a plurality of detectors a first measurement related to the plurality of burners when the furnace is operating in a stable condition;
determining, based at least in part on the first measurement from each of the plurality of detectors, a stable signal component representation for the furnace;
obtaining from each of the plurality of detectors a second measurement related to the plurality of burners when the furnace is operating in an unknown state;
determining, based at least in part on the second measurement from each of the plurality of detectors and the stable signal component representation, an unstable signal component representation for the furnace; and
detecting, using at least one processor, an instability in the furnace based at least in part on the unstable signal component representation and an instability threshold.

2. The method of claim 1, wherein the plurality of detectors comprises a plurality of pressure sensors.

3. The method of claim 1, wherein the plurality of detectors comprises a plurality of vibration sensors.

4. The method of claim 1, wherein the plurality of detectors comprises a plurality of video sensors.

5. The method of claim 1, wherein the stable signal component representation for the furnace comprises a stable covariance matrix.

6. The method of claim 1, wherein the unstable signal component representation for the furnace comprises an instability component covariance.

7. The method of claim 6, wherein the instability component covariance is calculated based on a stable covariance matrix and a current covariance matrix.

8. The method of claim 7, wherein the current covariance matrix is calculated based on the stable covariance matrix and a vector of the second measurement from each of the plurality of burners.

9. The method of claim 1, wherein the instability threshold is compared against a detection test statistic.

10. The method of claim 9, wherein the detection test statistic comprises a Neyman-Pearson detector.

11. The method of claim 9, further comprising computing the detection test statistic based on an inverse of a stable covariance matrix.

12. The method of claim 9, further comprising computing the detection test statistic based on an inverse of a current covariance matrix.

13. The method of claim 12, wherein the inverse of the current covariance matrix is computed via matrix inversion lemma.

14. The method of claim 1, wherein the plurality of detectors comprise one or more detectors of a first detector type and one or more detectors of a second detector type.

15. The method of claim 14, wherein obtaining the first measurement comprises:
obtaining a first time series of measurements from each of one or more detectors of a first detector type, the first time series of measurements from each of the one or more detectors of a first detector having a first sampling rate; and
obtaining a second times series of measurements from each of one or more detectors of a second detector type, the second time series of measurements from each of the one or more detectors of a second detector type having a second sampling rate.

16. The method of claim 15, wherein the first time series of measurements includes the first measurement for each of the one or more detectors of a first detector type, and wherein the second time series includes the first measurement for each of the one or more detectors of a second detector type.

17. The method of claim 16, further comprising converting the first time series of measurements and the second time series of measurements into a combined time series of measurements having a common sampling rate,
wherein determining the stable signal component representation for the furnace comprises determining the stable signal component representation for the furnace based at least in part on the combined time series of measurements.

18. The method of claim 17, wherein the common sampling rate comprises the first sampling rate.

19. The method of claim 17, wherein the common sampling rate comprises a sampling rate other than the first sampling rate and the second sampling rate.

20. The method of claim 15, wherein the first time series of measurements includes the second measurement for each of the one or more detectors of a first detector type, and wherein the second time series includes the second measurement for each of the one or more detectors of a second detector type.

21. The method of claim 20, further comprising converting the first time series of measurements and the second time series of measurements into a combined time series of measurements having a common sampling rate,
wherein determining the unstable signal component representation for the furnace comprises determining the unstable signal component representation for the furnace based at least in part on the combined time series of measurements.

22. The method of claim 15, wherein the first time series of measurements comprises at least one video frame.

23. The method of claim 22, further comprising converting the at least one video frame into a single value.

24. The method of claim 23, wherein the at least one video frame is converted into a single value based on an intensity of each pixel of the at least one video frame.

25. The method of claim 22, wherein the second time series of measurements comprises at least one value measured by a pressure sensor.

26. The method of claim 1, further comprising identifying an unstable subset of burners based at least in part on the unstable signal component representation.

27. The method of claim 26, wherein the unstable signal component representation comprises an instability component covariance.

28. The method of claim 26, further comprising using eigenvalue composition of the unstable signal component representation to obtain at least one dominant eigenvector.

29. The method of claim 28, wherein the at least one dominant eigenvector includes three components defining a point on a unit ball.

30. The method of claim 29, further comprising clustering the point with a plurality of other points obtained from a plurality of previous dominant eigenvectors.

31. The method of claim 30, further comprising identifying the unstable subset of burners based on the clustering.

32. The method of claim 31, wherein historical data is used to identifying the unstable subset of burners.

33. The method of claim 29, further comprising recovering a Green's function vector from the at least one dominant eigenvector.

34. The method of claim 33, wherein the at least one dominant eigenvector is normalized to obtain the Green's function vector.

35. The method of claim 26, wherein the unstable subset of burners comprises a single burner.

36. The method of claim 26, wherein the unstable subset of burners comprises a plurality of burners.

37. The method of claim 26, wherein the unstable subset of burners comprises a group of burners containing at least one unstable burner.

38. A system for detecting an instability in a furnace having a plurality of burners, the system comprising:
a plurality of detectors; and
at least one processor coupled to the plurality of detectors and configured to:
obtain from each of the plurality of detectors a first measurement related to the plurality of burners when the furnace is operating in a stable condition,
determine, based at least in part on the first measurement from each of the plurality of detectors, a stable signal component representation for the furnace,
obtain from each of the plurality of detectors a second measurement related to the plurality of burners when the furnace is operating in an unknown state,
determine, based at least in part on the second measurement from each of the plurality of detectors and the stable signal component representation, an unstable signal component representation for the furnace, and
detect an instability in the furnace based at least in part on the unstable signal component representation and an instability threshold.

39. The system of claim 38, configured for use in accordance with any of the methods described in claims 1 through 37.
